(19) United States
(12) Patent Application Publication
(10) Pub. No.: US 2026/0131486 A1
(43) Pub. Date: May 14, 2026

(54) GRIPPER DEVICE

(71) Applicant: Yung-Tsung CHANG, Taipei City (TW)

(72) Inventor: Yung-Tsung CHANG, Taipei City (TW)

(21) Appl. No.: 19/386,279

(22) Filed: Nov. 12, 2025

(30) Foreign Application Priority Data
Nov. 14, 2024 (TW) 113143886

(51) Int. Cl. B25J 15/08; B25J 15/00

(52) U.S. Cl. CPC B25J 15/08; B25J 15/0033

(57) ABSTRACT

The present invention provides a gripper device, comprising a movable frame portion, a gripping portion, and an actuating portion. The movable frame portion comprises a first through hole. The position of the movable frame portion is changed through a first linear movement. The gripping portion is utilized to grip an object. The gripping portion has a gripping structure accommodated within the first through hole and an accommodation space for accommodating the object. The actuating portion is used to push the movable frame portion to perform the first linear movement when the object is within the accommodation space, thereby causing the movable frame portion to push the gripping structure and grip the object.

### CROSS-REFERENCE TO RELATED APPLICATION

This application claims the benefit of Taiwan Patent Application No. 113143886, filed on Nov. 14, 2024, in the Taiwan Intellectual Property Office of the R.O.C, the disclosure of which is incorporated herein in its entirety by reference.

### FIELD OF INVENTION

The present invention relates to a technology for gripping objects or device under test (DUT); in particular, it relates to a gripper device that works without external forces.

### BACKGROUND OF THE INVENTION

With the advancement of technology, an automated equipment is increasingly being widely used in modern industrial production and manufacturing. Generally, automation refers to the process by which machines execute programs or instructions through their internal processing units without manual operation, and then take corresponding actions based on the results, thereby achieving the goal of automated production and manufacturing.

In the field of mechanical automation, mechanized automated gripping is a primary application. Generally, gripper devices consist of mechanical grippers and robotic arms to precisely grip objects, replacing manual labor. However, in practical use, the applicability of mechanical grippers is limited due to the different characteristics of various objects. Mechanical grippers mainly apply gripping forces to the object through two or more sets of gripper joints to grip it. However, some objects have smooth surfaces and are prone to slipping after being gripped. Increasing the gripping force applied by the gripper joints may damage the surface of the object.

Furthermore, conventional mechanical gripper mechanisms require additional power components, such as drive motors or pneumatic cylinders, which not only take up space but also limit their application range due to space constraints. In addition, adding extra power components also increases manufacturing costs.

In summary, an optical connector is needed to solve the problems of conventional technology. The above information disclosed in this section is only for enhancement of understanding of the background of the described technology and therefore it may contain information that does not form the prior art that is already known to a person of ordinary skill in the art.

### SUMMARY OF THE INVENTION

The present invention provides a gripper device, through the design of mechanism and elastic elements, enables the gripper device to grip and release objects without additional forces.

The present invention provides a gripper device that grips the surface of the object or device under test (DUT) from outside to inside, avoiding the drawback of rubbing into the surface of the object and thus preventing scratches on the surface of the object.

In one embodiment of the present invention, the present invention provides a gripper device, comprising a movable frame portion, a gripping portion, and an actuating portion. The movable frame performs a first linear movement relative to a fixing plate within a through hole, and the movable frame portion has a first through hole. The gripping portion is used to grip an object; the gripping portion has a gripping structure disposed within the first through hole, and the gripping structure has a gripping frame. The gripping portion performs a second linear movement relative to the fixing plate, causing the gripping frame to pass through the first through hole and positioning the object within the accommodation space. The actuating portion pushes the movable frame portion to perform the first linear movement when the object is positioned within the accommodation space, causing the movable frame portion to push against the gripping frame to grip the object.

The present invention will become better understood with reference to the following detailed description considered in connection with the accompanying drawings.

### BRIEF DESCRIPTION OF THE DRAWINGS

The detailed structure, operating principle and effects of the present invention will now be described in more details hereinafter with reference to the accompanying drawings that show various embodiments of the present invention as follows.

FIG. 1A is an exploded perspective view of an embodiment of the gripper device in the present invention.

FIG. 1B is an assembly diagram of the gripper device in the present invention.

FIGS. 1C and 1D are cross-sectional diagrams of the gripper device from sections AA and BB of FIG. 1B, respectively.

FIG. 2 is a three-dimensional diagram of the fixing plate in the present invention.

FIG. 3 is a schematic diagram of the movable frame portion in the present invention.

FIGS. 4A and 4B are three-dimensional diagrams of embodiments of the moving plate in different sides.

FIG. 5 is a three-dimensional diagram of an embodiment of the gripper device in the present invention.

FIGS. 6A and 6B are three-dimensional and cross-sectional schematic diagrams of the movable frame portion in the present invention.

FIG. 7 is a three-dimensional diagram of an embodiment of the pushing plate in the present invention.

FIGS. 8A to 8F are schematic diagrams of using the gripper device to grip the object in the present invention.

FIGS. 9A to 9C are schematic diagrams of using the gripper device to release the object in the present invention.

FIG. 10A is an exploded perspective view of another embodiment of the gripper device in the present invention.

FIGS. 10B and 10C are assembly diagrams from different perspectives of FIG. 10A.

FIG. 11A is a three-dimensional diagram of an embodiment of the gripping portion.

FIG. 11B is a three-dimensional diagram of another embodiment of the gripping structure in the present invention.

FIG. 11C is a three-dimensional diagram of another embodiment of the movable frame portion in the present invention.

FIGS. 12A to 12C are operational schematic diagrams of the gripper device from FIG. 10A.

FIGS. 12D to 12E are schematic diagrams of the interaction between the movable frame portion and the gripping structure from FIG. 10A.

### DETAILED DESCRIPTION OF THE PREFERRED EMBODIMENTS

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this invention will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way.

For convenience, certain terms employed in the specification, examples and appended claims are collected here. Unless defined otherwise, all technical and scientific terms used herein have the same meaning as commonly understood by one of the ordinary skill in the art to which this invention belongs.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The singular forms “a”, “and”, and “the” are used herein to include plural referents unless the context clearly dictates otherwise.

The following descriptions are provided to elucidate a gripper device and to aid it of skilled in the art in practicing this invention. These embodiments are merely exemplary embodiments and in no way to be considered to limit the scope of the invention in any manner.

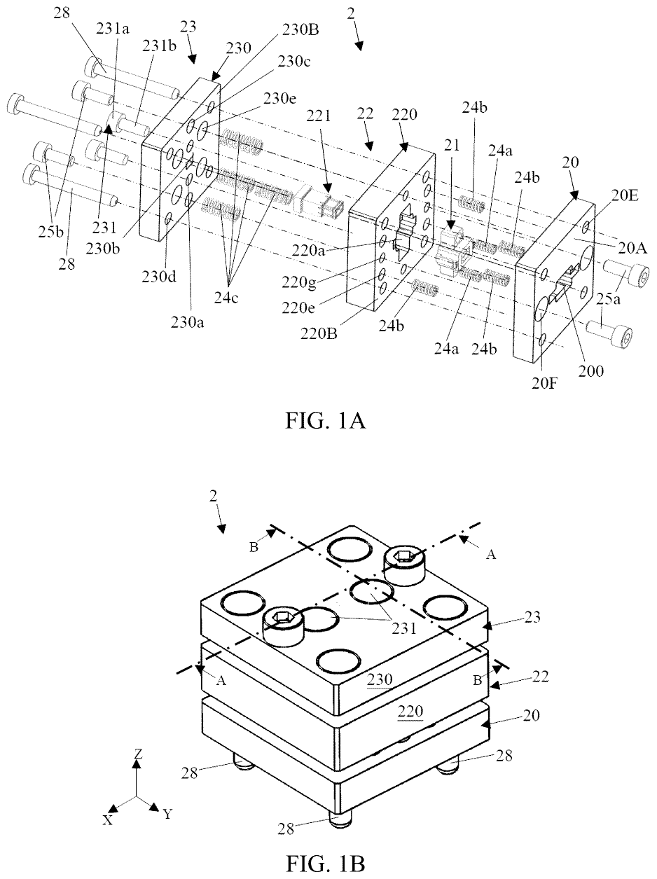

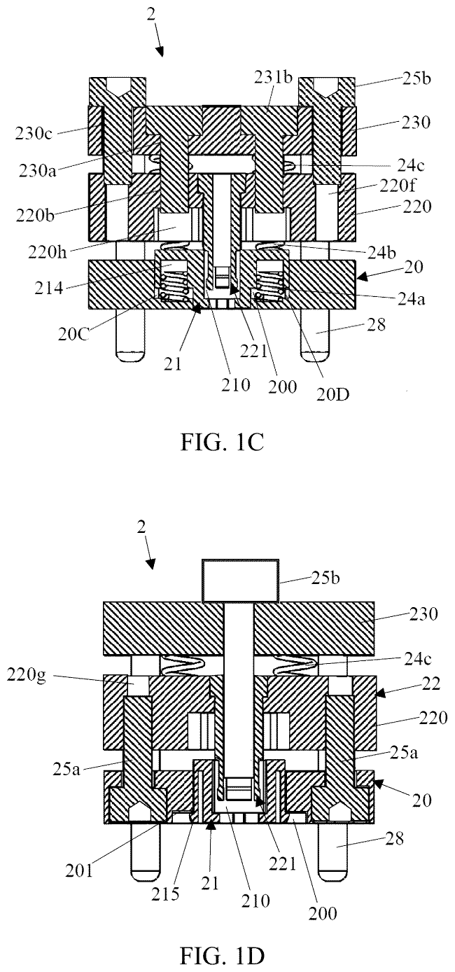

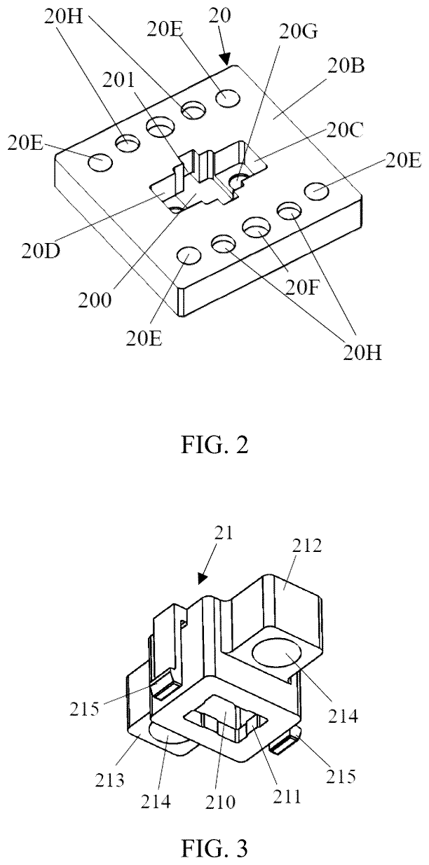

Please refer to FIGS. 1A to 1D, and FIGS. 2 and 3, FIG. 1A is an exploded perspective view of an embodiment of the gripper device, FIG. 1B is an assembly diagram of the gripper device, FIGS. 1C and 1D are cross-sectional diagrams of the gripper device from sections AA and BB of FIG. 1B, respectively, FIG. 2 is a three-dimensional diagram of the fixing plate, and FIG. 3 is a schematic diagram of the movable frame portion in the present invention. In this embodiment, the gripper device comprises a fixing plate 20, a movable frame portion 21, a gripping portion 22, and an actuating portion 23. The fixing plate 20 has a first surface 20A and a second surface 20B. The fixing plate 20 has a through hole 200 passing through the first surface 20A and the second surface 20B, a plurality of first guiding holes 20E passing through the first surface 20A and the second surface 20B, and a plurality of guiding through holes 20F passing through the first surface 20A and the second surface 20B. A plurality of first leaning holes 20H are disposed on the second surface 20B, and the first grooves 20C and 20D are set on both sides of the through hole 200. As shown in FIG. 2, a second leaning hole 20G is set on the bottom surface of the first grooves 20C and 20D.

The movable frame portion 21 performs a first linear movement relative to the fixing plate 20 within the through hole 200. The movable frame portion 21 has a first through hole 210, and side blocks 212 and 213 respectively correspond to the first grooves 20C and 20D on two sides of the first through hole 210. Each side block 212 and 213 has a first accommodation groove 214 corresponding to the second leaning hole 20G. A first elastic element 24a, which is a spring in this embodiment, is disposed between the first accommodation groove 214 and the second leaning hole 20G. An end of the first elastic element 24a is accommodated within the first accommodation groove 214, and the other end of the first elastic element 24 a is accommodated in the second leaning hole 20G, so that the movable frame portion 21 would compress the first elastic element 24a during the first linear movement by an external force, and then return to the original or initial position through the elastic force of the first elastic element 24a after the external force is removed. The first through hole 210 of the movable frame portion 21 has a first protrusion structure 211 corresponding to an inner wall of the second surface 20B. The outer side of the movable frame portion 21 has a latching structure 212, which is a cantilever structure that can be bent by a force and return to its original or initial position after the force is removed.

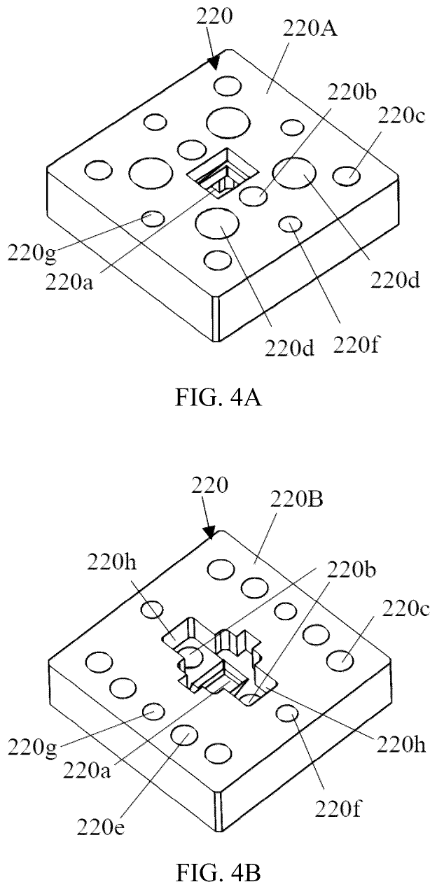

The gripping portion 22 is used to grip objects, and the gripping portion 22 further comprises a moving plate 220, a gripping structure 221, and a second elastic element 24b. Please refer to FIGS. 1, 4A, and 4B, FIGS. 4A and 4B are three-dimensional diagrams of embodiments of the moving plate in different sides. In this embodiment, the moving plate 220 has a first surface 220A, a second surface 220B, a third through hole 220a corresponding to the first through hole 210 and penetrating through the first surface 220A and the second surface 220B, a plurality of fourth through holes 220b penetrating through the first surface 220A and the second surface 220B and corresponding to the movable frame portion 21, a plurality of second guiding holes 220c penetrating through the first surface 220A and the second surface 220B, a plurality of third leaning holes 220d formed on the first surface 220A, a plurality of fourth leaning holes 220e formed on the second surface 220B, a plurality of first locking holes 220f formed on the first surface 220A, and a plurality of second locking holes 220g formed on the second surface 220B. The first locking holes 220f and the second locking holes 220g can be through holes or blind holes with threads.

Please refer to FIGS. 1A, 2, 4A, and 4B, the second elastic element 24b is disposed between the fixing plate 20 and the moving plate 220. In this embodiment, one end of the second elastic element 24b is accommodated within the first leaning hole 20H of the fixing plate 20, and the other end is accommodated within the fourth leaning hole 220e. This allows the moving plate 220 to return to its original or initial position after moving towards the fixing plate 20. In one embodiment, the second elastic element 24b is not a necessary structure; for example, it can be replaced by a cylinder or a guide rail, allowing the moving plate 220 to move toward and return to its original or initial position. In this embodiment, a predetermined distance between the fixing plate 20 and the moving plate 220 through the fixing element 25a. In this embodiment, the fixing element 25a is designed as a bolt with threads at its end. It is guided through the guiding through hole 20F and then locked into the corresponding second locking hole 220g. This distance can be adjusted through the fixing element 25a. In this embodiment, there are two fixing elements 25a, but it is not limited thereto. The third through hole 220a further has a second groove 220h corresponding to the first grooves 20C and 20D, and the fourth through hole 220b penetrates from the first surface 20A to the second groove 220h.

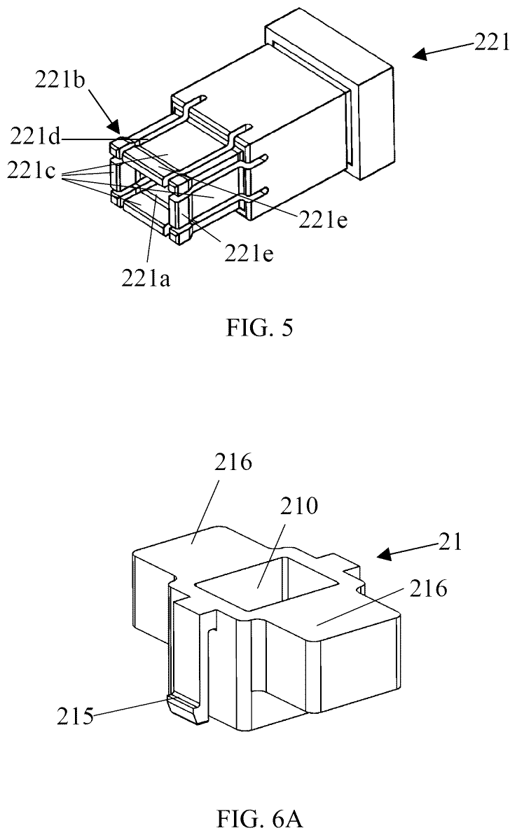

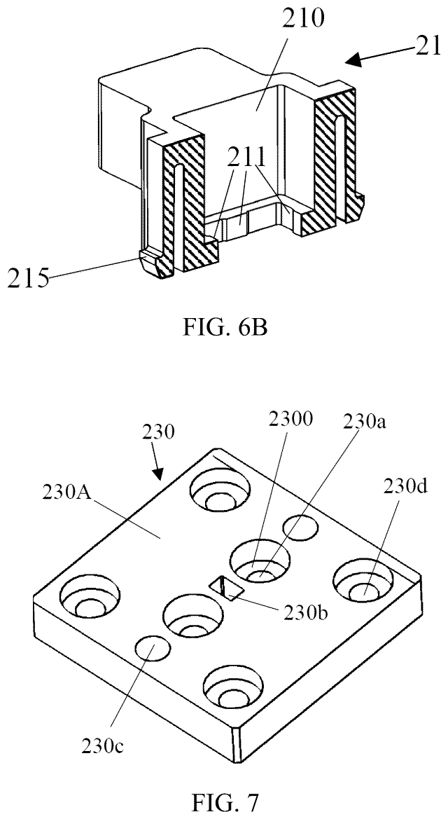

As shown in FIG. 5, which is a three-dimensional diagram of an embodiment of the gripper device in the present invention. In this embodiment, the gripping structure 220 has a hollow channel 221a and a gripping frame 221b which surrounds the hollow channel 221a. The gripping structure 220 further has a plurality of gripping members 221c, and a gap 221d, which is disposed on both sides of each gripping member 221c. This arrangement makes the gripping member 221c flexible. Each gripping member 221c has a second protrusion structure 221e corresponding to one side of the movable frame portion 21. As shown in FIGS. 6A and 6B, the gripping frame 220b passes through the first through hole 210 via a second linear movement, thereby positioning the object within the gripping frame 220b.

As shown in FIGS. 1C to 1D, and 6A to 6B, FIGS. 6A and 6B are respectively three-dimensional and cross-sectional schematic diagrams of the movable frame portion in the present invention. In this embodiment, the movable frame portion 21 further has a first protrusion structure 211 corresponding to the second protrusion structure 221e. This first protrusion structure 211 interferes with the second protrusion structure 221e during the first linear movement of the movable frame portion 21. During the movement, the second protrusion structure 221e is pushed, causing the gripping member 221c to be bent towards the object and thus grip the object. The movable frame portion 21 has a latching structure 215 corresponding to the through hole 200, which is engaged with the side wall 201 of the through hole 200 when the movable frame portion 21 pushes the gripping frame 221b to grip the object.

Please refer to FIGS. 1 and 7, FIG. 7 is a three-dimensional diagram of an embodiment of the pushing plate in the present invention. The actuating portion 23 further has a pushing plate 230 and a pushing rod 231. The pushing plate 230 has a fifth through hole 230a, a sixth through hole 230b, a guiding through hole 230c, a third guiding hole 230d, and a fifth leaning hole 230e. The fifth through hole 230a penetrates through the first surface 230A and the second surface 230B of the pushing plate 230 to allow the pushing rod 231 to pass through. It should be noted that the sixth through hole 230b is an optional opening structure. If a leaning structure is required to generate a stop effect for the gripping element, a sixth through hole 230b can be made. The leaning structure, such as a rod-shaped structure, is used to be passed through the sixth through hole 230b and then into the hollow channel 221a. In this embodiment, the pushing rod 231 has an leaning portion 231a and a pushing post 231b, wherein the pushing post 231b passes through the fifth through hole 230a, and the leaning portion 231a is leaned against the leaning ring 2300 on the fifth through hole 230a located on the first surface 230A. A guiding hole 230c allows the fixing element 25b to pass through. In this embodiment, a predetermined distance is maintained between the moving plate 220 and the pushing plate 230 by the fixing element 25b. In one embodiment, the pushing post 231b and the fifth through hole 230a have threads and can be fastened mutually, but it is not a limited therein, and those skilled in the art can choose appropriate means as needed. For example, in another embodiment, a baffle can be placed over the leaning portion 231a, and then the baffle is locked onto the first surface 230A.

In this embodiment, the fixing element 25b is designed as a bolt with threads at its end. It passes through the guiding hole 230c and is then locked into the corresponding second locking hole 220g. The distance can be adjusted through the fixing element 25 b. In this embodiment, there are two fixing elements 25b, but is not limited herein. The third guiding hole 230d allows the guiding post 28 to pass through. The guide post 28 passes through the third guiding hole 230d, then through the second guiding hole 230d of the moving plate 220 and through the first guiding hole 20E from the second surface 20B of the fixing plate 20, and then protrudes from the first surface 20A of the fixing plate 20. Between the pushing plate 230 and the moving plate 220, there are a plurality of third elastic elements 24c, one end of which is disposed into the fifth leaning hole 240e, and the other end is accommodated into the third leaning hole 220d on the first surface 220A of the moving plate 220. This allows the third elastic elements 24c to be compressed when the pushing plate 230 is forced and moved towards the moving plate 220. When the force is removed, the third elastic elements 24c can push the pushing plate 230 back to its original or initial position. In another embodiment, the third elastic element may not be required. For example, it can be replaced by a cylinder or a guiding rail, so that the pushing plate 230 can move forward and return to the original or initial position.

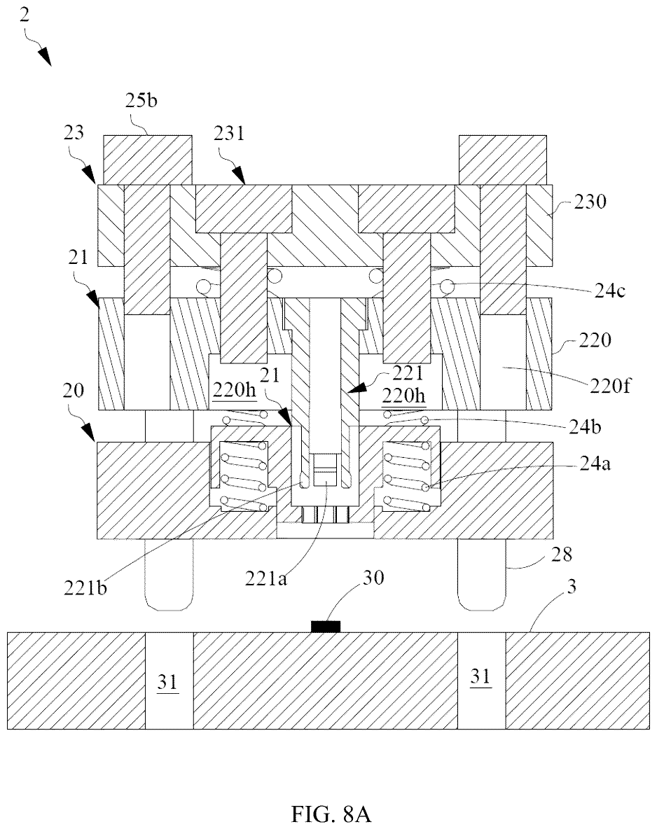

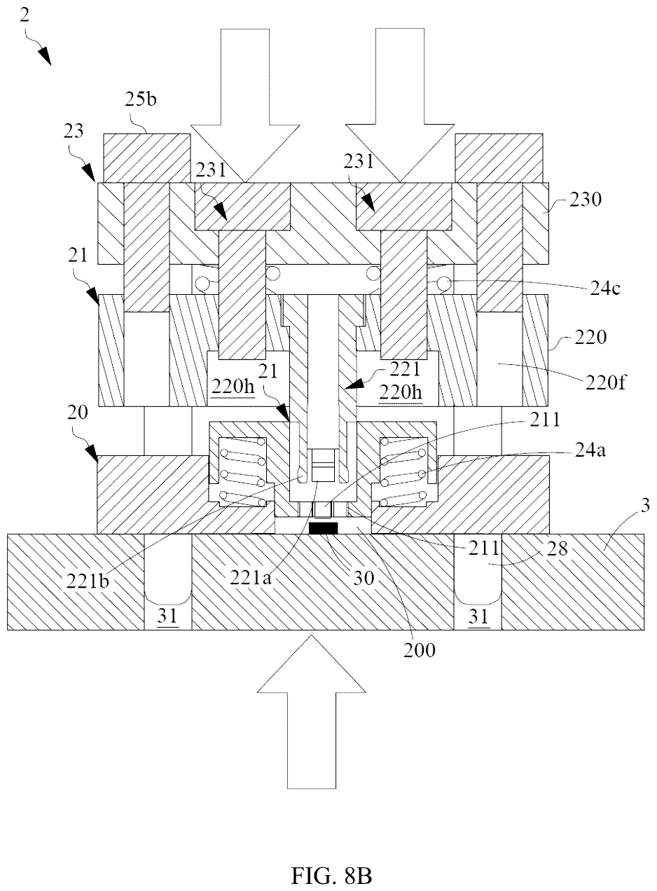

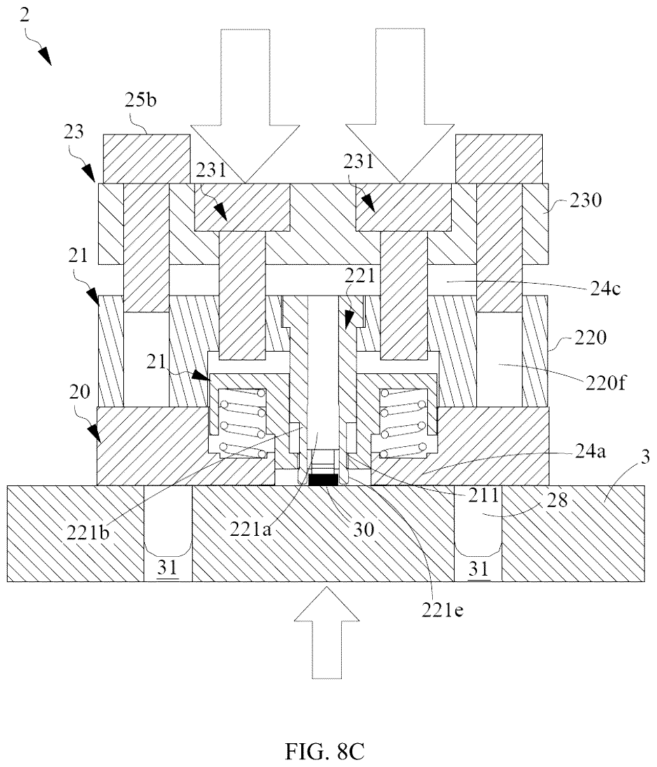

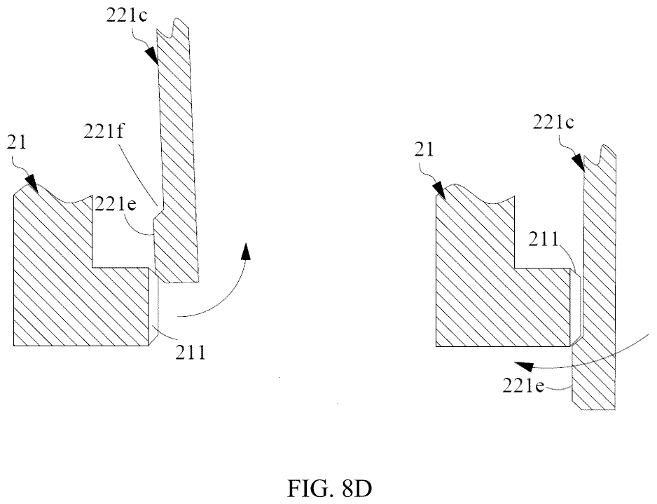

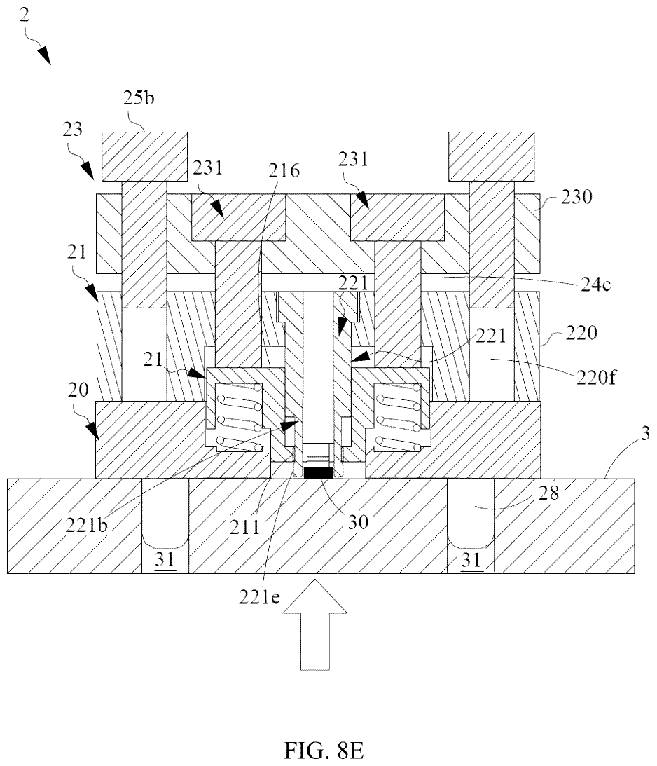

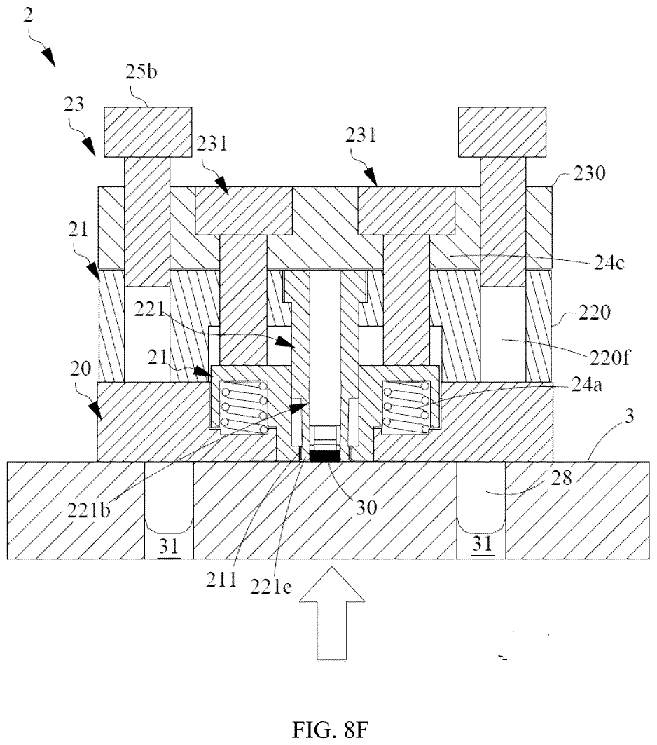

The operation of the gripper device of the present invention would be described below. As shown in FIGS. 8A to 8E, the gripper device can be installed on the front end of a robotic arm (not shown). FIGS. 8A to 8E are the cross-section along the X-axis from FIG. 1B. As shown in FIG. 8A, an object 30 is placed on the supporting platform 3, which has guiding post holes 31. When the gripper device 2 moves above the object 30 and the guiding post 28 of the gripper device 2 corresponds to the guiding post hole 31, the gripper device 2 moves downward or the supporting platform 3 moves upward, so that the guiding post 28 penetrates into the guiding post hole 31, allowing the gripper device 2 to achieve an alignment effect, so that the hollow channel 221a of the gripping structure 221 corresponds to the object 30. When the fixing plate 20 is leaned against the supporting plate 3, the object 30 is accommodated within the through hole 200, forming the state shown in FIG. 8B. Subsequently, as shown in FIG. 8C, through the relative movement between the gripper device 2 and the supporting platform 3, the moving plate 220 is further leaned against the fixing plate 20, while simultaneously compressing the second elastic element 24b shown in FIG. 8A, causing the second elastic element 24b to accumulate the force to push the moving plate 220 to its original or initial position. When the moving plate 220 is leaned against the fixing plate 20, the gripping structure 221 also moves relatively toward the fixing plate 20 and is leaned against the surface of the fixing plate 20 since the gripping structure 221 is disposed on the moving plate 220, thereby causing the object 30 to be surrounded by the gripping frame 221b of the gripping structure 221.

It should be noted that, as shown in FIG. 8D, although the second protrusion structure 221e surrounded by the gripping frame 221b will interfere with the first protrusion structure 211 on the inner wall of the first through hole 210 when the gripping structure 221 moves downward through the first through hole 210, gaps 221d are designed on both sides of the gripping member 221c, so that the gripping member 221c can be bent. That is, when there is interference, the gripping member 221c bends in the counterclockwise direction without hindering the gripping structure 221 from moving downward. Since a recess 221f is set above the second protrusion structure 221e, the first protrusion structure 211 no longer interferes with the second protrusion structure 221e when the gripping structure 221 moves downward and is leaned against the fixing plate 20, causing the gripping member 221c to spring back in the clockwise direction, allowing the first protrusion structure 211 to protrude into the recess 221f.

As shown in FIG. 8E, after the moving plate 220 contacts the fixing plate 20, the pushing plate 230 proceeds to move downward, causing an end portion of the pushing rod 231 to be leaned against the leaning surface 216 above the movable frame portion 21. Next, as shown in FIG. 8F, as the pushing plate 230 proceeds to move towards the moving plate 220, the pushing rod 231 pushes against the leaning surface 216 of the movable frame portion 21 to move towards the object 30. When the pushing plate 230 is leaned against the moving plate 220, the movable frame portion 21 is pushed onto the surface of the supporting plate 3. Simultaneously, the third elastic element 24c, as shown in FIG. 8A, is compressed, causing it to accumulate the force to push the pushing plate 220 back to its original or initial position. The movable frame portion 21 also compresses the first elastic element 24a, allowing the first elastic element 24a to push the movable frame portion 21 back to its original or initial position after the pushing rod 231 disengages from the leaning surface 216. Since the first protrusion structure 211 on the inner wall of the movable frame portion 21 pushes against the second protrusion structure 221e on the gripping member 221c, the gripping member 221c moves toward the outer edge of the object 30, and then is leaned against the outer edge of the object 30, thus gripping the object 30.

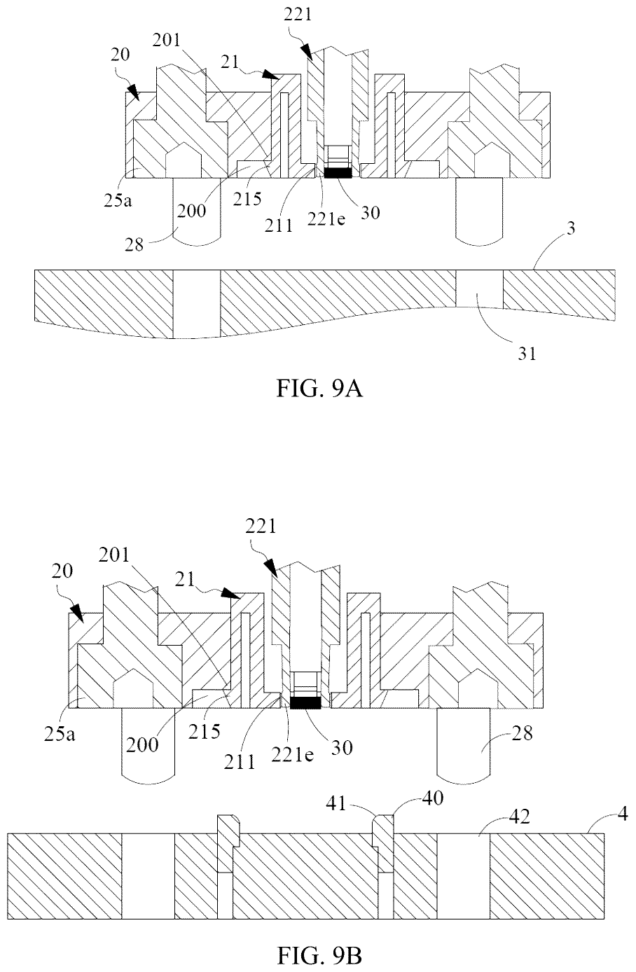

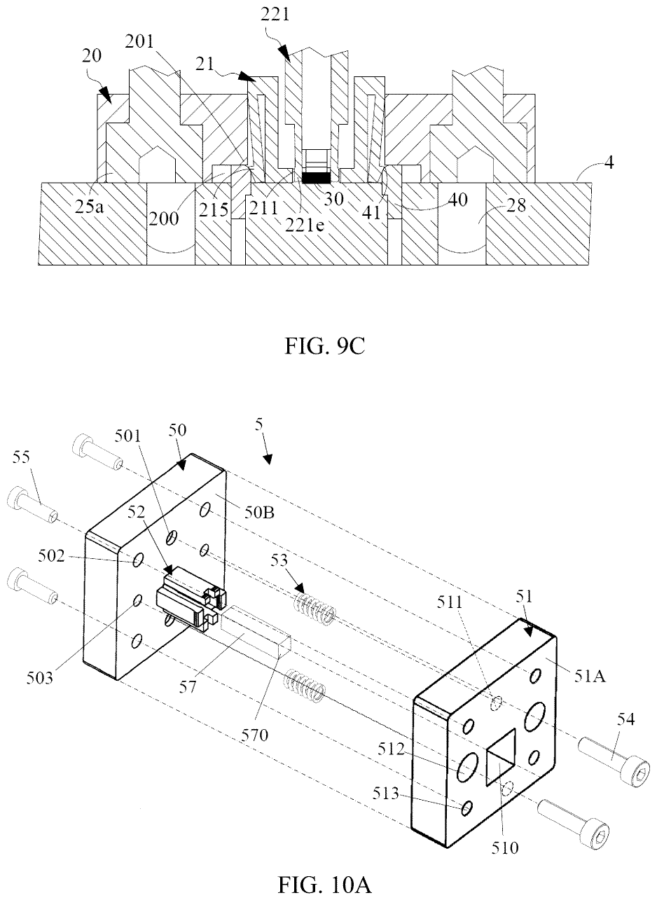

It should be noted that, after the object 30 is gripped, the gripper device 2 disengages from the supporting plate 3 and moves the object 30 to a predetermined position. This embodiment is mainly to prevent the object 30 from falling off after the gripper device 2 leaves the supporting plate 3, as the fixing plate 20, without external restraint, is bounced back to its original or initial position by the second elastic element 24b. As shown in FIGS. 9A to 9C, which are schematic diagrams of using the gripper device to release the object in the present invention. In this embodiment, the cross-section is along the Y-axis from FIG. 1B. From this cross-section, it can be seen that the latching structures 215 are set on both sides of the movable frame portion 21. In the state of gripping the object 30 shown in FIG. 8F, the movable frame portion 21 is also engaged with the fixing plate 20 by buckling with the side wall 201 inside the through hole 200. Afterwards, as shown in FIG. 9A, the entire gripping device 2 can be disengaged from the supporting plate 3 while maintaining the state of gripping the object 30.

Next, as shown in FIG. 9B, the robotic arm moves the gripper device 2 to the placement area. In this embodiment, the placement area also has a supporting plate 4. Unlike the aforementioned supporting plate 3, the supporting plate 4 in this embodiment has an unlocking portion 40 with an unlocking surface 41, which is used to release the latching relationship between the latching structure 215 and the side wall 201. In this embodiment, the gripper device 2 moves above the supporting plate 4, aligning the guiding post 28 with the guiding post hole 42 on the supporting plate 4. The guiding post 28 and the guiding post hole 42 create an alignment effect, allowing the gripper device 2 to place the object 30 in the accurate position. Subsequently, as shown in FIG. 9C, the gripper device 2 moves downward, causing the guiding post 28 to pass through the guiding post hole 42. At the same time, the unlocking surface 41 on the unlocking portion 40 is leaned against the latching structure 215. After the fixing plate 20 contacts the supporting plate 4, the unlocking portion 40 pushes the latching structure 215 away from the side wall 201. After the latching structure 215 disengages from the side wall 201, the second elastic element 24b and the third elastic element 24c, which have accumulated an elastic force, are released to push the moving plate 220 and the pushing plate 230 to the position shown in FIG. 8B. This causes the movable frame portion 21 to move upward, disengaging the first protrusion structure 211 from the second protrusion structure 221e, thereby releasing the object 30. Subsequently, the gripper device can repeat the operations described in FIGS. 8A-8F and 9A-9C, repeatedly grip the object to a predetermined position and release the object from the predetermined position.

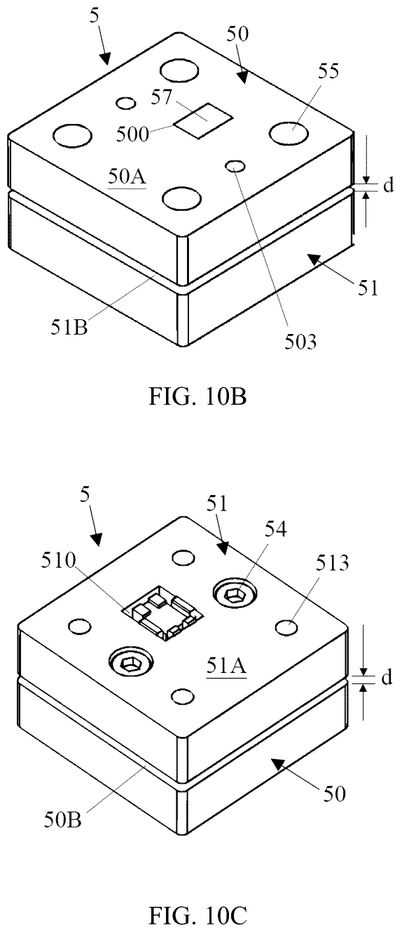

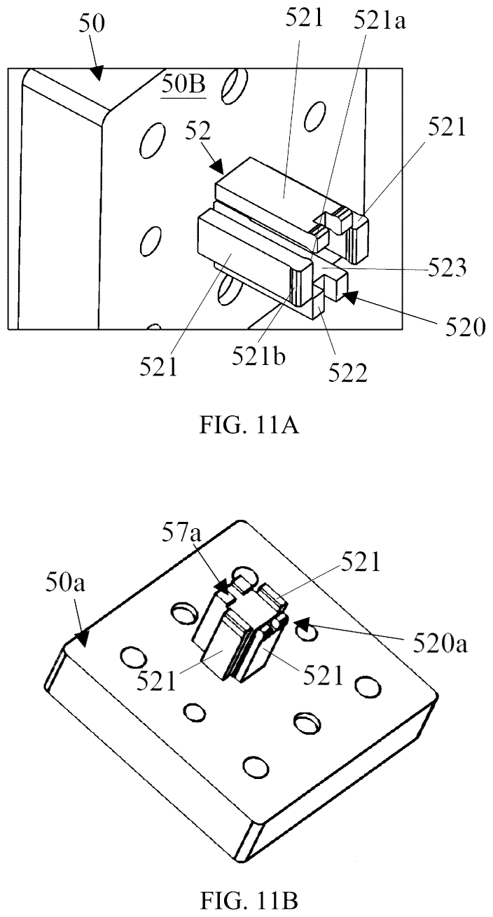

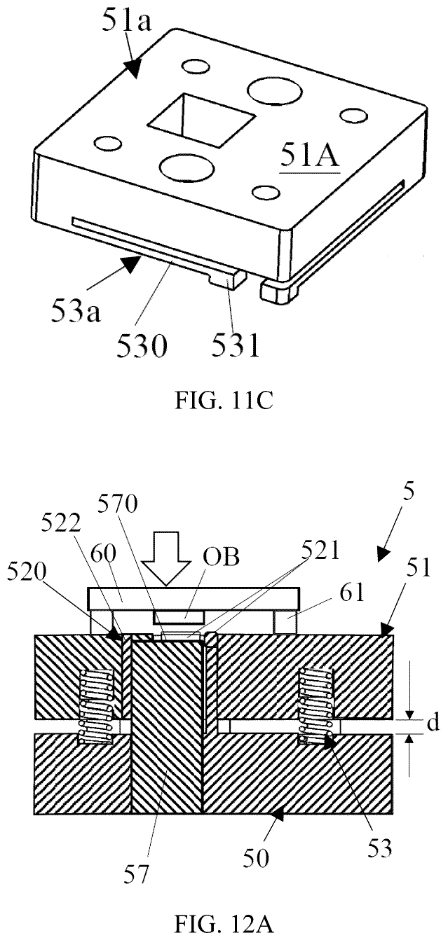

Please refer to FIGS. 10A to 10C and 11A, FIG. 10A is an exploded perspective view of another embodiment of the gripper device, FIGS. 10B and 10C are assembly diagrams from different perspectives of FIG. 10A, and FIG. 11A is a three-dimensional diagram of an embodiment of the gripping portion. In this embodiment, the gripper device 5 comprises a fixing plate 50, a movable frame portion 51, a gripping portion 52, and an actuating portion 53. The fixing plate 50 has a through hole 500 passing through the first surface 50A and the second surface 50B, a first leaning hole 501 formed on the second surface 50B, a first guiding hole 502 passing through the first surface 50A and the second surface 50B, and a first locking hole 503 that can pass through the first surface 50A and the second surface 50B or only formed on the second surface 50B. The movable frame portion 51 is disposed on one side of the fixing plate 50, and in this embodiment, it is disposed on the second surface 50B. The movable frame portion 51 has a first through hole 510 that passes through the first surface 51A and the second surface 51B, a second leaning hole 511 opened on the second surface 51B, a second guiding hole 512 that passes through the first surface 51A and the second surface 51B, and a third guiding hole 513 that can pass through the first surface 51A and the second surface 51B or is only opened on the second surface 50B.

The gripping portion 52 has a gripping structure 520, which has at least one gripping rod 521 and a positioning rod 522. The gripping rod 521 and the positioning rod 522 are arranged around the periphery of the accommodation space 523 for accommodating an object. In this embodiment, in order to support the object, the gripper device 5 further has a supporting member 57 passing through the through hole 500. The supporting surface 570 of the supporting member 57 is located within the accommodation space 523 to stop the gripped object. In this embodiment, the gripping structure 520 has three gripping rods 521, one end of each gripping rod 521 is connected to the second surface 50B of the fixing plate 50, and the other end of each gripping rod 521 is located on the periphery of the accommodation space 523. Each gripping rod 521 has a first gripping protrusion 521a corresponding to the accommodation space 523, and a second gripping portion 521b opposite to the first gripping protrusion 521a. A first through hole 510 is used to accommodate the gripping portion 52. The movable frame portion 51 changes position by a first linear movement. In this embodiment, the gripping structure 520 changes its position relative to the first through hole 510 through the linear movement of the movable frame portion 51. For example, the gripping structure 520 protrudes from the first through hole 510 or is wholly or partially accommodated within the first through hole 510.

Please refer to FIG. 11B, FIG. 11B is a three-dimensional diagram of another embodiment of the gripping structure in the present invention. The structure of the gripping structure is similar with that in FIG. 11A, except that the supporting member 57a of this embodiment integrates the supporting member 57 and the positioning rod 522 of previous embodiment. The actuating portion 53 is used to push the moving frame portion 51 to perform a first linear movement when the object is located in the accommodation space 523, so that the moving frame portion 51 pushes the gripping structure 520 to grip the object. In this embodiment, the actuating portion 53 is an elastic element, such as a spring. One end of the actuating portion 53 is accommodated in the first leaning hole 501 and the other end of the actuating portion 53 is accommodated in the second leaning hole 511. The number of actuating portions 53 is not limited to two shown in the FIG. 10B. Furthermore, it should be noted that the actuating portions are not limited to elastic elements, such as drive motors or pneumatic cylinders can also be used. In another embodiment, as shown in FIG. 11C, which is a schematic diagram of another embodiment of the movable frame portion in the present invention. In this embodiment, the movable frame portion 51a, in addition to the aforementioned features of the movable frame portion, further integrates the structure of the actuating portion. In this embodiment, four actuating portions 53a are respectively disposed on the four sides of the movable frame portion 51a and located on the second surface 51B. Each actuating portion 53a further has a cantilever rod 530 and a protrusion block 531, wherein the protrusion block 531 is used to be leaned against the second surface 50B of the fixing plate 50 when the movable frame portion 51a moves toward the fixing plate 50, causing the cantilever rod 530 to deform and thereby accumulating the elastic force.

In this embodiment, the gripper device 5 further has a plurality of fixing elements 54 and guiding rods 55. The fixing elements 54 are secured to the first locking hole 503 of the fixing plate 50 via the second guiding hole 512 for adjusting the distance d, which represents the distance of the first linear movement, between the movable frame portion 51a and the fixing plate 50. A plurality of guiding rods 55 pass through the first guiding hole 502 and are inserted into the third guiding hole 513 corresponding to the first guiding hole 502. The guiding rods 55 are used to adjust the alignment of the fixing plate 50 and the movable frame portion 51a.

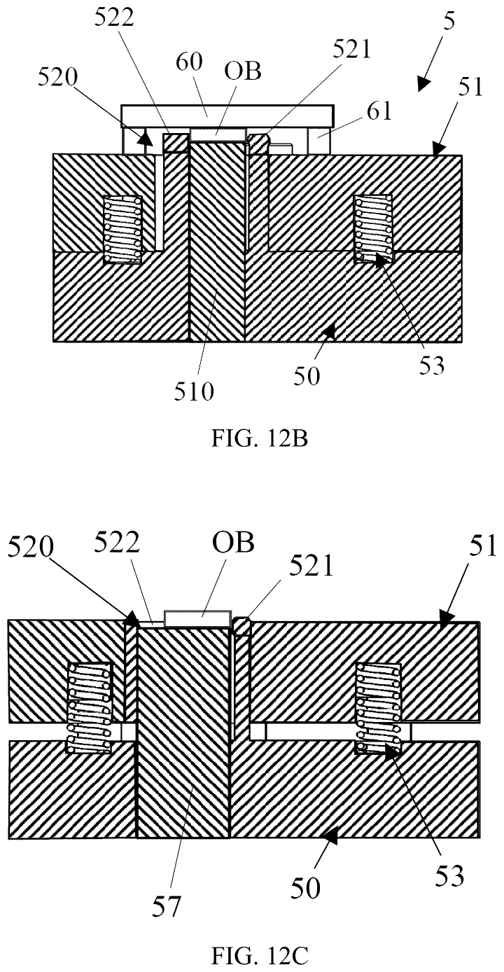

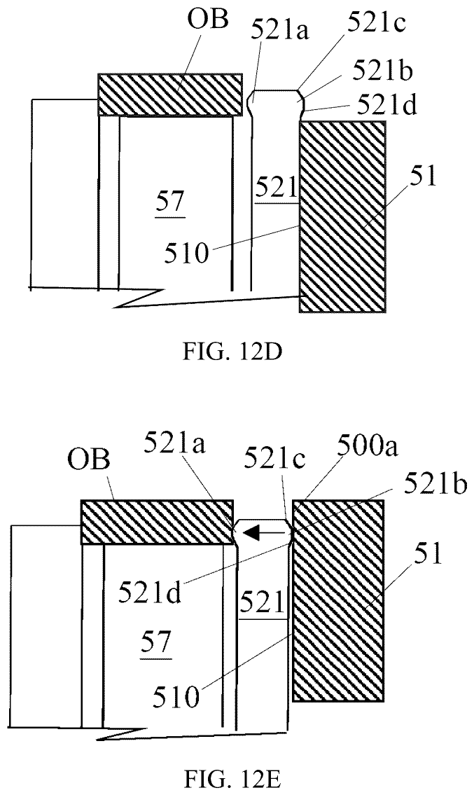

Please refer to FIGS. 12A to 12C, FIGS. 12A to 12C are operational schematic diagrams of the gripper device from FIG. 10A. An object OB is placed on a supporting platform 60. The gripper device 5 can move to grip the object, or the supporting platform 60 can move to allow the object OB to be gripped by the gripper device 5. This embodiment is illustrated by the movement of the supporting platform 60. As shown in FIG. 12A, the supporting platform 60 has a top post 61, which applies a force on the movable frame portion 51, causing the movable frame portion 51 to move downward by a distance d, so that the end of the gripping structure 520 protrudes from the movable frame portion 51, forming the state shown in FIG. 12B. As the movable frame portion 51 moves, it compresses the actuating portion 53, causing the actuating portion 53 to accumulate an elastic force. This force is used to push the movable frame portion 51 back to its original or initial position. When the top post 61 disengages from the movable frame portion 51, for example, the supporting platform 60 moves away or the gripper device 5 moves, pushing the movable frame portion 51 back to its original or initial position. As shown in FIG. 12B, after the moving frame portion 51 moves and the end of the gripping structure 520 protrudes from the moving frame portion 51, the end of the gripping structure 520 is no longer constrained by the moving frame portion 51. Therefore, the object OB can be easily accommodated in the accommodation space 523 of the gripping structure 520.

After the object OB is placed into the accommodation space 523, the gripper device 5 disengages from the top post 61 of the supporting platform 60, or the supporting platform 60 disengages from the moving frame portion 51 of the gripper device 5, causing the external force, which was applied to the moving frame portion 51, to disappear. After the external force disappears, the elastic force stored in the actuating portion 53 pushes the moving frame portion 53, causing the moving frame portion 53 to return to its original or initial position, as shown in FIG. 12C. It should be noted that, in the aforementioned embodiment, although the first surface 51A of the moving frame portion 51 faces upwards, in another embodiment, the first surface 51A of the moving frame portion 51 can face downwards, with the supporting platform 60 and the object OB positioned below the first surface 51A. The operation of the gripper device remains the same as in FIGS. 12A to 12C, and would not be described herein.

It should be noted that, as shown in FIGS. 12D and 12E, FIGS. 12D to 12E are schematic diagrams of the interaction between the movable frame portion and the gripping structure from FIG. 10A. In FIG. 12D, the first through hole 510 of the movable frame portion 51 moves downwards to below the first gripping protrusion 521a and the second gripping protrusion 521b of the gripping rod 521. After the external force disappears, the movable frame portion 51 moves upwards under the push of the actuating portion. The upper and lower sides of the first gripping protrusion 521a and the second gripping protrusion 521b have inclined surfaces 521c and 521d, when the movable frame portion 51 moves upwards to return to its original or initial position, the hole wall of the first through hole 510 of the movable frame portion 51 can move upwards along the inclined surface 521d without obstruction. During the movement, the hole wall of the first through hole 510 pushes against the gripping rod 521, causing the gripping rod 521 to move towards the side of the object OB, and finally causing the first gripping protrusion 521a to be leaned against the side of the object OB, creating a gripping effect.

It will be understood that the above description of embodiments is given by way of example only and that various modifications may be made by those with ordinary skill in the art. The above specification, examples, and data provide a complete description of the present invention and use of exemplary embodiments of the invention. Although various embodiments of the invention have been described above with a certain degree of particularity, or with reference to one or more individual embodiments, those with ordinary skill in the art could make numerous alterations or modifications to the disclosed embodiments without departing from the spirit or scope of this invention.

What is claimed is:

1. A gripper device, comprising:
a movable frame portion, having a through hole and changing position through a first linear movement;
a gripping portion, having a gripping structure accommodated within the first through hole, and the gripping structure having an accommodation space for accommodating an object; and
an actuating portion, wherein when the object is located within the accommodation space, the movable frame portion is pushed by the actuating portion to perform the first linear movement, causing the movable frame portion to push against the gripping structure to grip the object

2. The gripper device of claim 1, wherein the gripping structure has a plurality of gripping members, both sides of the each gripping member have gaps.

3. The gripper device of claim 2, wherein the movable frame portion has a first protrusion structure, and the gripping member has a second protrusion structure corresponding to a side of the movable frame portion; when the first protrusion structure in the movable frame portion performs the first linear movement, the first protrusion structure pushes against the second protrusion structure, causing the gripping member to bend towards the object and grip the object.

4. The gripper device of claim 1, comprising a fixing plate, which has a through hole, wherein the gripping structure has a gripping frame with an accommodation space, the gripping portion performs a second linear movement relative to the fixing plate, so that the gripping frame passes through the first through hole and positions the object within the accommodation space.

5. The gripper device of claim 4, wherein the actuating portion pushes the moving frame portion to perform the first linear movement, causing the moving frame portion to push against the gripping structure to grip the object.

6. The gripper device of claim 4, wherein the movable frame portion has a latching structure corresponding to the through hole, the latching structure engages with a side wall of the through hole when the movable frame portion pushes against the gripping structure to grip the object.

7. The gripper device of claim 6, comprising:
a supporting plate; and
a release structure, setting on the supporting plate and corresponding to the latching structure, wherein the release structure pushes against the latching structure by an upward movement, causing the latching structure to disengage from the side wall, whereby the moving frame portion to perform a first linear movement in opposite direction to release the object on the supporting plate.

8. The gripper device of claim 4, wherein an elastic element is disposed between the movable frame portion and the fixing plate.

9. The gripper device of claim 1, wherein the gripping member has a moving plate, which has a third through hole corresponding to the first through hole and a fourth through hole corresponding to the movable frame portion, the third through hole allows the gripping structure to pass through, and the gripping structure has a first leaning structure which is leaned against a second leaning structure on the third through hole.

10. The gripper device of claim 9, wherein the actuating portion comprises:
a pushing plate, having a fifth through hole; and
a pushing rod, an end of the pushing rod being coupled to the fifth through hole, and the other end of the pushing rod corresponding to the fourth through hole;
wherein the pushing plate pushes the pushing rod to pass through the fourth through hole, causing an end of the pushing rod to be leaned against the movable frame portion, thereby driving the movable frame portion to perform the first linear movement.

11. The gripper device of claim 4, comprising a plurality of guiding rail, which are slidely connected with the fixing plate, the gripping portion, and the actuating portion.

12. The gripper device of claim 1, comprising a fixing plate, which has a through hole, wherein the gripping structure has a least one gripping rod, an end of the gripping rod is connected to the fixing plate, and the other end of the gripping rod is located on periphery of the accommodation space.

13. The gripper device of claim 12, wherein the actuating portion is an elastic element disposed between the fixing plate and the movable frame portion.

14. The gripper device of claim 12, comprising a supporting member passing through the through hole, wherein a supporting surface of the supporting member is located within the accommodation space to stop the object.

15. The gripper device of claim 4, wherein the actuating portions are multiple, which are respectively disposed on the fixing plate, the each actuating portion has a cantilever rod and a protrusion block, an end of the cantilever rod is connected to the fixing plate and the other end of the cantilever rod is connected to the protrusion block.
